(19) United States
(12) Patent Application Publication
(10) Pub. No.: US 2013/0341194 A1
(43) Pub. Date: Dec. 26, 2013

(54) ELECTRODE FOR BATTERIES, IN PARTICULAR FOR LITHIUM ION BATTERIES, AND PRODUCTION THEREOF

(71) Applicants: Bernd Fuchsbichler, Graz (AT); Martin Schmuck, Graz (AT)

(72) Inventors: Bernd Fuchsbichler, Graz (AT); Martin Schmuck, Graz (AT)

(73) Assignee: VARTA Micro Innovation GmbH, Graz (AT)

(21) Appl. No.: 13/985,002

(22) PCT Filed: Feb. 10, 2012
(86) PCT No.: PCT/EP2012/052249

§ 371 Date: Aug. 27, 2013

(30) Foreign Application Priority Data
Feb. 16, 2011 (DE) 10 2011 004 233.4
Aug. 26, 2011 (EP) 11178969.9

(51) Int. Cl. H01M 4/04

(52) U.S. Cl. CPC H01M 4/0452
USPC 205/50; 205/57

(57) ABSTRACT

A method of producing electrodes for lithium ion batteries including forming the electrodes formed by electro-chemical deposition, from a mixture including particles made of at least one electrochemically active material, a binder and a solvent and/or dispersing agent.

### TECHNICAL FIELD

This disclosure relates to a method, of producing electrodes for batteries, in particular for lithium ion. batteries. The disclosure also relates to electrodes produced or producible according to the method as well as to cells or batteries having such electrodes.

### BACKGROUND

The term “battery” originally referred to a plurality of electrochemical cells in a casing connected in series. Nowadays, even single electrochemical cells are frequently referred to as a battery. During the discharge of an electrochemical cell, an energy-supplying chemical reaction takes place, which is composed, of two electrically inter-coupled, however, spatially separated partial reactions. In an oxidation process, electrons are liberated at the negative electrode, resulting in an electron flow via an external load to the positive electrode by which a corresponding amount of electrons is received. Thus, a reduction process takes place at the positive electrode. Simultaneously, that results in an ion flow inside the cell which corresponds to the electrode reaction. The flow is ensured by an ionically conductive electrolyte. The discharge reaction is reversible in secondary cells and batteries. If, in this context, the terms anode and cathode are used, one usually refers to the electrodes in accordance with their discharge function. As a result, the negative electrode is called anode (oxidation) and the positive electrode is called cathode (reduction) in such cells.

Among the known secondary cells and batteries, comparatively high energy densities are achieved in particular by lithium ion batteries. Generally, those batteries comprise composite electrodes that include electrochemically inactive materials besides electrochemically active materials. Basically, all materials capable of receiving and releasing lithium ions may be considered as electrochemically active materials for lithium ion batteries. In this regard, the prior art includes for the negative electrode in particular particles based on carbon such as graphitic carbon or non-graphitic carbon materials capable of intercalation of lithium. Furthermore, also metallic and semi-metallic materials that can be alloyed with, lithium may be used. For example, the elements tin, antimony and silicon are capable of forming intermetallic phases with lithium. Generally, all electrochemically active materials are contained in the electrodes in the form of particles.

Electrode binders and current conductors are to be named as electrochemically inactive materials in the first place. Electrons of the electrodes are supplied or drained via current conductors. Electrode binders ensure mechanical stability of the electrodes as well as the inter-contacting of the particles of electrochemically active material and the contacting to the current conductor. In addition, conductivity-improving additives may support an improved electric connection of the electrochemically active particles to the current conductor. All electrochemically inactive materials should be electrochemically stable at least in the potential range of the respective electrode and have chemically inert characteristics towards common electrolyte solutions.

The lithiation of carbon-based active materials is generally accompanied by a significant increase in volume. Thus, the volume of Individual particles may increase by up to 10% when receiving lithium ions. The volume increase is even larger in the case of metallic and semi-metallic storage materials. In fact, those materials have a significantly greater storage capacity than carbon-based materials. However, when lithiating tin, antimony and silicon, also the volumetric expanse is frequently significantly greater (in the first charging cycle up to 300%). When releasing lithium ions, the volume of the respective active materials decreases again, and there are great stresses within the particles made of active material as well as a shifting of the electrode structure as the ease may be. The involved mechanical strain of the electrodes partly leads to contact losses between adjacent active material particles to a substantial extent. De-contacting is frequently accompanied by creeping capacity losses which may result in non-usability of the affected electrode.

In known methods of producing electrodes for lithium ion batteries, usually a pasty electrode material comprising the above-mentioned electrochemically active and inactive materials is applied to a suitable current conductor, for example, in a rolling process or a process using a doctor blade. Usually, the paste is applied to the conductor in a thin layer and subsequently subjected to a heat treatment. To Improve the electrochemical properties of the applied electrode layer, the developing layer may be compressed under pressure, for example, by roiling, pressing or calendaring processes. Pressure treatment mostly causes an improved inter-contacting of the particles made of active material as well as an improved contacting to the current collector.

According to WO 2009/012899, the production of electrodes for lithium ion batteries is preferably effected from a water-based paste including a cellulose derivative as hinder as well as dispersed particles made of metals or semimetals that can be alloyed with lithium or graphite particles as electrochemically active particles. Electrodes produced that way exhibit a good cyclization performance. Despite the great volume expansion which the metallic or semi-metallic storage materials are subject to during the lithiation, the contact losses between adjacent particles made of active material seem to occur, but in a less pronounced manner in said electrodes.

However, in those processes, it is problematic that cellulose derivatives often show a comparatively brittle and hardly elastic performance, which mostly has negative effects on the processability of the electrodes and thus in particular on the contacting of the current collector. The method usually requires the use of softeners which may be added to the above-mentioned paste.

It could therefore be helpful to provide electrodes for batteries, in particular lithium ion batteries, which have an improved capacitive performance when aging.

### SUMMARY

We provide a method of producing electrodes for lithium ion batteries including forming the electrodes formed by electro-chemical deposition from a mixture including particles made of at least one electrochemically active material, a binder and a solvent and/or dispersing agent.

We also provide an electrode for a lithium ion battery, produced or producible by our

method mentioned above.

We further provide a lithium ion cell or lithium ion battery including at least one electrode.

### BRIEF DESCRIPTION OF THE DRAWINGS

FIG. 1 shows a fleece made of copper-coated synthetic material filaments (SEM, 500-fold magnification), which is used as electrically conductive substrate.

FIG. 2 shows a cross-sectional view (SEM, 1000-fold and 1500-fold magnification) of an electrode produced by a classic doctor blade procedure.

FIG. 3 shows a cross-sectional view (SEM, 500-fold and 1000-fold magnification) of an electrode produced by electrochemical deposition.

### DETAILED DESCRIPTION

Our methods for producing electrodes for lithium ion batteries employ a mixture comprising particles of at least one electrochemically active material, a binder and a solvent and/or dispersing agent. In contrast to known methods, the mixture is not simply processed in a mechanical manner. Instead, our method is characterized in that the electrodes are electrochemically deposited out of the mixture. They are formed by electrochemical deposition of the particles made of at least one active material and the binder on an electrically conductive substrate.

Generally, besides an electrolyte, at least two electrodes as well as an external voltage source are required for the technical realization of an electrochemical deposition. When applying a voltage, cations contained in the electrolyte wander to the negative electrode and anions contained in the electrolyte wander to the positive electrode. That results in the reductive or oxidative deposition of substances at the electrodes subject to receipt and release of electrons. In this case, the mixture comprising the particles made of the electrochemically active material, the binder, and the solvent and/or dispersing agent serves as an electrolyte, which will be explained in more detail below.

It is preferred that the electrically conductive substrate on which the electrodes are deposited is a current conductor, in particular a current conductor as usually used for electrodes of lithium ion batteries. The electrically conductive substrate may in principle be composed of any conductive material provided that it is inert under the electrochemical conditions of the deposition process. Preferably, it is composed of a metal or a metal alloy. In the production of lithium ion batteries, aluminum and copper are particularly preferred. Generally, an aluminum substrate is used as current conductor for positive electrodes and copper is used as current conductor tor negative electrodes.

The electrically conductive substrate is preferably directly submerged into the mixture and connected with a voltage source to achieve the deposition. Depending on the components contained in the mixture, it may be preferred to connect the electrically conductive material either as a cathode or as an anode and thus to achieve a cathodic or anodic deposition on the substrate. In both cases, e.g. a copper electrode, in particular a copper mesh electrode, may be used, as a counter electrode.

Regardless of the fact which type of electrically conductive substrate is used, the option of the electrochemical deposition allows formation of layer-type electrodes having a very constant thickness.

Generally, the electrically conductive substrate may have any geometry. Thus, for example, also conductors having a complex, three-dimensional structure as, for example, present in a fleece or in a felt, may be considered as substrates. The structure-forming element in such conductors are fibers, filaments and/or needles. The latter are usually processed into a planar structure having numerous cavities between the structure-forming elements. Also porous solids such as foams (in particular metallic foams such as nickel foams, for example, as described in DE 40 17 919, U.S. Pat. No. 4,251,603 and BP 0 185 830) may be considered as conductors with complex, three-dimensional structure. With conventional methods (e.g. a doctor blade), a uniform coating of such conductors with electrode material is not possible. Thus, satisfactory contact between the electrodes and such substrates can be achieved only in a restricted manner. The problem can be solved by electrochemical deposition according to our method.

The rate of deposition may in particular he influenced by specific variation of the amperage, voltage and temperature as well as by chemical modifications of the electrolyte (e.g. variation of concentration, composition and pH value). The current density is another value generally important for electrochemical depositions and directly depending on the abovementioned parameters. Current density is defined as the ratio between amperage and area through which an electric current passes through. Besides the deposition rate, also the thickness of the electrode layer to be deposited may be set by those parameters as well as the quality of, in particular in terms of the homogeneity, may be controlled. Electrochemical depositions according to our method are preferably conducted at a current density of 1 mA/cm² to 30 mA/cm², particularly preferred 2 mA/cm² to 10 mA/cm². During the deposition, voltage is preferably 1 V to 10 V.

The temperature of me mixture-from which the electrodes are deposited is preferably set to a value of 0.5° C. to 80° C., in particular 20° C. to 50° C., during the deposition.

The deposition period, i.e. the time period in which a voltage is applied for deposition of the electrodes, is preferably set to a value of 5 s to 3.0 minutes, in particular 10 s to 10 min.

Formation of the electrodes is preferably effected by electrochemical deposition out of an aqueous medium. That means that the mixtures as solvent and/or dispersing agent at least by majority comprise water. Where appropriate, it may additionally comprise a proportion of at least one further solvent (such as an alcohol, for example). However, particularly preferred it exclusively contains water as solvent and/or dispersing agent.

The solvent and/or dispersing agent is preferably contained in the mixture in a proportion of 50 weight percent to 99 weight percent, particularly preferred 75 weight percent to 95 weight percent (in each case with respect to-the overall weight of the mixture). The proportion of solvent and/or dispersing agent in the .mixture is usually a multiple of the overall amount of the remaining components.

The binder in the mixture preferably is a binder that can be processed in water. Suitable are binders that have anionic or cationic properties in aqueous solutions, i.e. which move in the direction of the anode or in the direction of the cathode when applying a voltage, or which can be transformed into anions or cations in an aqueous solution, for example, by specified variation of the pH values of the solution. Particularly preferred, polyanionic or polycationic binders are used as binders.

Particularly preferably, the binder is a binder based on a polysaccharide. Polysaccharides are sugars having monosaccharide units, generally with a statistic distribution of molecular size. A plurality of monosaccharides (e.g. glucose or fructose) forms a chain.

Polysaccharides suitable as binder for electrodes am described in detail in WO 2009/012899. The contents of WO 2009/012899 are hereby incorporated by reference.

Preferably, a polysaccharide modified with reactive groups, in particular a cellulose derivative, is used as polysaccharide based electrode binder. As generally known, cellulose is an unbranched polysaccharide which is generally formed by several 100 or 10000 β-D-glucose molecules, the latter connected via β-(1,4) glycoside bonds.

The reactive groups are in particular functional groups, which may be polarized or ionized in a polar solvent and/or may undergo a condensation reaction with OH groups. Preferably, the reactive groups are hydroxyl groups, carboxyl groups, carboxylate groups, carbonyl groups, cyano groups, sulfonic acid groups, halogen carbonyl groups, carbamoyl groups, thiol groups and/or amino groups.

Particularly preferably, the mixture used in the method preferably comprises carboxyalkyl cellulose as binder, preferably carboxymethyl cellulose (CMC), in particular sodium carboxymethyl cellulose (Na—CMC).

Carboxymethyl celluloses are cellulose derivatives, where at least a part of the OH groups is connected to a carboxymethyl group as ether. For producing carboxymethyl cellulose, usually, in a first step, cellulose is converted to reactive alkali cellulose and subsequently transformed into carboxymethyl cellulose by means of chloro acetic acid. The cellulose structure is maintained in the procedure, in particular under alkaline conditions, carboxyalkyl celluloses are soluble relatively good in water as polyanions. Correspondingly, carboxymethyl celluloses such as Na—CMC may tor example be deposited anodically on the electrically-conductive substrate.

Particularly preferably, Na—CMC is used as binder with a substitution rate of 0.5 to 3, preferably 0.8 to 1.6. The substitution rate indicates the average number of modified hydroxyl groups per monosaccharide unit in a cellulose derivative.

Particularly preferably, the mixture used in our method comprises, chitosan or a chitosan derivative as binder.

Chitosan is a naturally occurring polyaminosaccharide derived from chitin. Generally, it has a linear structure and is composed of β-(1-4)-linked N-acetyl-D-glucosamine (2-amino-2-desoxy-α/β-D-glueopyranose) and D-glucosamm (deacylated 2-amino-2-desoxy-α/β-D-glucopyranose) in an arbitrary distribution. Generally, it is obtained from chitin by means of deacetylation. in particular under acidic conditions, chitosan mostly is soluble in water as polycation. Correspondingly, chitosan may be cathodically deposited on the electrically conductive substrate.

The binder is contained in the mixture preferably in a share of 0.1 weight percent to 10.0 weight percent, in particular 0.2 weight percent to 3 weight percent, particularly preferred 0.3 weight percent to 2 weight percent.

The proportion of the binder in the mixture may significantly influence the viscosity of the mixture and thus also, in conjunction with the above-mentioned parameters, the deposition performance of the mixture components. During the deposition process, binder molecules present as anion or cation may carry along uncharged mixture components, for example, the particles made of the at least one electrochemically active material. The binder molecules deposit to the electrically conductive substrate connected as cathode or anode and form a three-dimensional structure, in which the particles of the at least one electrochemically active material are embedded. To obtain a most homogeneous electrode layer on the conductive substrate, the proportion of the binder in the mixture is ideally within the above-mentioned ranges, in particular if the binder is any of the above-mentioned monosaccharides.

Generally, the method may produce both negative and positive electrodes, in particular for lithium ion batteries. Depending on the electrode type to be produced a different electrochemically active material is used.

For example, suitable electrochemically active materials for negative electrodes are described in detail in the aforementioned WO 2009/012899. In this case, in particular particles made of lithium intercalating, carbon based materials such as graphite can be considered as particles made of the at least one electrochemically active material. Suitable non-carbon based lithium intercalating materials may also be used. Suitable carbon-based or non-carbon based lithium intercalating materials are generally known and do not require further explanation.

As an alternative or in addition to the lithium intercalating compounds, also particles made of metals and/or semimetals that can be alloyed with lithium, may be used as particles made of the at least one electrochemically active material. In particular aluminum, silicon, antimony and tin, which may also be used in a combination thereof, can be considered as metals and/or semimetals that can be alloyed with lithium. Also composite materials of the named metals and/or semimetals and the aforementioned carbon-based materials may be used.

The particles made of the at least one electrochemically active material preferably have an average particle size of 20 nm to 100 μm.

As electrochemically active materials for positive electrodes, in particular lithium metal oxide compounds or lithium metal phosphate compounds are preferred. For example, particles from a compound of the group consisting of LiNi_{1/3}Mn_{1/3}Co_{1/3}O₂, LiCoO₂, LiMn₂O₄, LiFePO₄ and LiMnPO₄ may be used.

Besides the components described already, the mixture preferably contains at least an additive increasing the electric conductivity in the electrode to be produced, in particular a carbon based additive such as carbon nano tubes (CNTs) and/or carbon black and/or a metallic additive. Such additives are known and do not require detailed explanation.

Furthermore, the mixture used may in particular contain a softener, in particular a softener of ester-type nature such, as tri ethyl citrate. In this case, softeners of ester-type nature are to refer to softeners made of organic compounds having at least one ester group. The softener in the mixture is preferred in a proportion of 0.5 weight percent to 5 weight percent, in particular 0.8 weight percent to 2 weight percent.

In particular examples of our method, a step of mostly complete removal of the solvent and/or dispersing agent contained in the deposited layer follows the deposition of the electrodes. The step preferably is a heat treatment.

To improve the electrochemical properties of the electrode formed by electrochemical deposition, it may also be preferred to contact the deposited layer made of the binder and the electrochemically active material under pressure to the conductive substrate in a subsequent step. For example, that may be effected in the context of a rolling, pressing or calendaring step. Such a pressure treatment mostly effects a better inter-contacting of the particles made of active material contained in the layer as well as a better contacting o the electrode conductor.

The electrodes produced or producible by our method and cells and/or batteries equipped with the electrodes are also the subject-matter of this disclosure. In accordance with the above explanations, the electrodes are in particular electrodes for lithium ion batteries and the cells and/or batteries are lithium ion cells and batteries. The electrodes comprise an electrically conductive substrate acting as electric conductor, as described above, as well as a layer deposited thereon comprising the described particles made of an electrochemically active material and one of the binders.

Preferably, the electrode layer on the electrically conductive substrate contains as components:
0.1 weight percent to 20 weight percent, preferably 0.1 weight percent to 10 weight percent, in particular 0.1 weight percent to 3 weight percent, of the described binder,
20 weight percent to 95 weight percent of the particles consisting of the described, electrochemically active material.
0.1 weight percent to 10 weight percent of the described at least one conductivity additive, and
0.1 weight percent the 10 weight percent of the described at least one softener, wherein the percentage indications preferably add up to 100 weight percent.

In the electrode, the binder forms a matrix, in which the particles made of the electrochemically active material are preferably present finely dispersed and homogeneously distributed. The; nature of the binder has already been described, Reference is hereby made to the corresponding embodiments.

In this case, the term “matrix” refers to a material in which particles made of one or a plurality of further materials are embedded, in this case the particles made of the electrochemically active material as well as, where appropriate, additive particles (e.g. particles increasing the electrical conductivity of the electrode to be produced) are. The particles generally do not enter into a fixed bond to the binder matrix. A connection is rather effected physically, for example, by adhesion forces, or mechanically. However, it is also possible that the described metallic or semi-metallic particles have OH groups on their surface in the case that the surface is at least partially oxidized. In particular, that can be true if the particles are brought into contact with water, A covalent bond in particular to polysaccharide-based electrode binders such as Na—CMC or the aforementioned chitosan can be formed via OH groups, in particular by a condensation reaction under a loss of water. The covalent bond between the particles and the matrix results in a particularly firm and resistant electrode structure, which is excellently capable of resisting the afore-mentioned electrode-internal mechanic stresses during charge procedures and discharge procedures.

Particularly preferably, the electrode comprises a conductor with a complex, three-dimensional structure of fibers, filaments and/or needles as electrically conductive substrate, as described above. Thus, the conductor may be composed of thin metal filaments, for example. Particularly preferably, also filaments, fibers and/or needles may be used with a core made of synthetic material and an electrically conductive shell, for example made of a metal. As an alternative, also the afore-mentioned porous conductors such as, for example, foams may be considered.

Further features arise from the following description of preferred examples. Here, individual features may be realized in each case on their own or together in a combination thereof in an example. The described preferred examples only serve for explanatory purposes and for a better understanding and are not to be understand as limiting in any manner.

### EXAMPLES

### (1) Anodic Deposition of Na—CMC

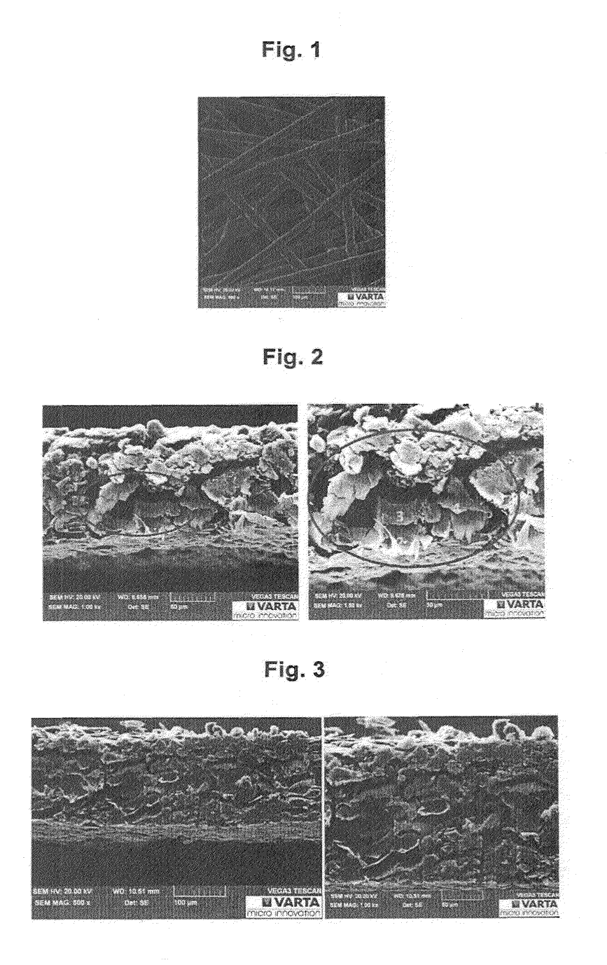

In the following, the anodic deposition of electrodes made of mixtures being composed of varying components is described. The deposition as in each case effected on a copper current conductor (POLYMET® XII-1 Cu, a copper-coated, polyester fibrous web as shown in FIG. 1), In each case one copper mesh metal electrode acted as counter electrode. Tables 1 to 3 describe the composition of a first, a second and a third mixture out of which the electrodes were deposited.

TABLE 1
composition of the first mixture

| Components | Sample weight [g] |
|---|---|
| Na-CMC | 0.25 |
| Graphite | 1.50 |
| Si powder (Ø 50 nm) | 0.50 |
| Super P (carbon black) | 0.25 |
| Triethyl citrate | 0.30 |
| H₂O (demineralized) | 30.00 |

Demineralized water was provided for production of the first mixture and the NA—CMC was introduced under agitation. Subsequently, all the other components were added under agitation.

During the subsequent production of electrodes by electrochemical deposition from the first mixture, the cupper current conductor acted as anode. The temperature of the mixture was set to 25° C. The electrochemical deposition was effected at a current density of 6 mA/cm² for 120 s.

TABLE 2
Composition of the second mixture

| Components | Sample weight [g] |
|---|---|
| Na-CMC | 0.25 |
| Si powder (Ø 50 nm) | 0.50 |
| Super P (carbon black) | 0.25 |
| Triethyl citrate | 0.30 |
| H₂O (demineralized) | 15.00 |

Production of the second mixture as well as the subsequent production of electrodes by electrochemical deposition from the mixture was generally effected, as in the case of the first mixture. However, the electrochemical deposition was effected at a current density of 2 mA/cm² for 120 s.

TABLE 3
Composition of the third mixture

| Components | Sample weight [g] |
|---|---|
| Na-CMC | 0.25 |
| Graphite | 4.50 |
| Super P (carbon black) | 0.25 |
| Triethyl citrate | 0.30 |
| H₂O (demineralized) | 30.00 |

Production of the third mixture as well as the subsequent production of electrodes by electrochemical deposition from the mixture was generally effected as in the case of the. first mixture. However, the electrochemical deposition was effected at a current density of 2 mA/cm² for 120 s.

### (2) Cathodic Deposition of Chitosan and Composite Material

In the following, the anodic deposition of electrodes from a fourth mixture containing chitosan as a binder is described. The deposition was effected on a copper current conductor (POLYMET®) XII-1 Cu). A copper mesh electrode acted as a counter electrode. In Table 4, the composition of the mixture out of which the electrodes were deposited is described.

TABLE 4
Composition of the fourth mixture

| Components | Sample weight [g] |
|---|---|
| Chitosan | 0.25 |
| Graphite | 3.20 |
| Si powder (Ø 50 nm) | 0.80 |
| Printex U ® (carbon black) | 0.50 |
| Ethylene glycol butyl ether | 5.00 |
| polyvinyl alcohol | 0.25 |
| HCL (30%) | 0.20 |
| H₂O (demineralized) | 60.00 |

For production of the fourth mixture, 20 g of the demineralized water was provided. Subsequently, 0.25 g chitosan, and 0.25 g polyvinyl alcohol (as softener) was added under agitation and 0.2 g hydrochloric acid (30%) was added. After dissolving the chitosan, the black carbon was added and a further 10 g of the demineralized water was added to the mixture. Subsequently, all the other mixture components were added under agitation. The ethylene glycol butyl ether served as co-solvent. Subsequently, another 25 g of demineralized water was added.

During the subsequent production of electrodes by electrochemical deposition from the fourth mixture, the copper current conductor acted as a cathode. The temperature of the mixture was adjusted to 25° C. The electrochemical deposition was effected at a current density of 6 mA/cm² for 120 s.

### Comparative Tests

A first dry mixture of 5 weight percent Na—CMC, 5 weight percent light carbon black and 90 weight percent graphite was suspended in water (weight ratio dry mixture: water=1:6). The water contained 1 weight percent triethyl citrate. The resulting solution or suspension resulted in an electrochemical deposition on a copper current conductor (POLYMET® XII-1 Cu). Deposition was effected for 120 seconds at a current density of approximately 2 mA/cm² and a temperature of 25° C.

A second dry mixture composed of 5 weight percent Na—CMC, 5 weight percent light black carbon and 90 weight percent graphite was suspended in water (weight ration dry mixture:water=1:4). The water contained 1 weight percent triethyl citrate. The resulting solution was applied on a copper current conductor (POLYMET® XII-1 Cu) by a squeegee. The wet film thickness was approximately 150 μm on each side.

After drying, the electrodes resulting from the two methods had a comparable thickness. However, they differed from one another in their electrochemical properties. The electrochemically deposited electrodes showed a better charge and discharge performance in comparative tests.

An explanation for that can be found in the cross-sectional views shown in FIGS. 2 and 3. The electrodes produced by electrochemical deposition have a more homogeneous distribution of the electrochemically active material (of the graphite particles) as compared to the electrodes produced by a doctor blade process. In particular, numerous cavities could be seen in the interior of the electrode in the cross-sectional view of the electrode produced by a doctor blade. One example for that is the cavity formed by the fibers 1 to 6 of the current conductor, which can be seen in FIG. 2. Such cavities are not filled with electrode active material in conventional doctor blade procedures, in contrast, the electrode produced by electrochemical deposition has no comparable cavities.

By a subsequent calendaring, the charge and discharge performance of both electrodes could be improved. The performance of both electrodes adapted to one another in the procedure.

1.-13. (canceled)

14. A method of producing electrodes for lithium ion batteries comprising forming the electrodes formed by electro-chemical deposition from a mixture comprising particles made of at least one electrochemically active material, a binder and a solvent and/or dispersing agent.

15. The method according to claim 14, wherein the particles made of the at least one electrochemically active material and the binder are deposited on an electrically conductive substrate.

16. The method according to claim 14, wherein the electrochemical deposition from the mixture is effected anodically or cathodically.

17. The method according to claim 14, wherein the electrodes are deposited out of an aqueous solution.

18. The method according to claim 14, wherein the mixture contains the solvent and/or dispersing agent in a proportion of 50 weight percent to 99 weight percent.

19. The method according to claim 14, wherein the binder is at least one selected from the group consisting of a polysaccharide, a polysaccharide modified with reactive groups, a cellulose derivative, carboxymethyl cellulose (CMC), sodium carboxymethyl cellulose, and chitosan.

20. The method according to claim 14, wherein the mixture contains the binder in a proportion of 0.1 weight percent to 10.0 weight percent.

21. The method according to claim 14, wherein at least part of the electrochemically active particles in the mixture are particles made of a carbon-based, lithium intercalating material and/or of a metal and/or a semi-metal which can form an alloy together with lithium.

22. The method according to claim 14, wherein at least part of the electrochemically active particles in the mixture are particles made of a lithium metal oxide compound and/or made of a lithium metal phosphate compound.

23. The method according to claim 14, wherein the mixture contains at least one conductivity additive increasing conductivity of the electrode to be produced selected from the the group consisting of carbon nano tubes (CNTs), carbon black and a metallic additive.

24. The method according to claim 14, wherein the mixture includes at least one softener, an aliphatic polyester, glycerin triacetate and/or a hydroxycarboxylic acid ester, and triethyl citrate.

25. An electrode for a lithium ion battery, produced or producible according to the method according to claim 14.

26. A lithium ion cell, or lithium ion battery comprising at least one electrode according to claim 25.
